(19) United States
(12) Patent Application Publication
(10) Pub. No.: US 2026/0110276 A1
(43) Pub. Date: Apr. 23, 2026

(54) LADDER FRAME FOR ENGINE

(71) Applicant: TOYOTA JIDOSHA KABUSHIKI KAISHA, Toyota-shi (JP)

(72) Inventor: Ryoji ANDOH, Toyota-shi (JP)

(73) Assignee: TOYOTA JIDOSHA KABUSHIKI KAISHA, Toyota-shi (JP)

(21) Appl. No.: 19/302,531

(22) Filed: Aug. 18, 2025

(30) Foreign Application Priority Data
Oct. 17, 2024 (JP) 2024-182002

(51) Int. Cl. F02F 7/00

(52) U.S. Cl. CPC F02F 7/0065; F02F 7/0021; F02F 2200/06

(57) ABSTRACT

A ladder frame, for an engine, includes a crank cap portion made of cast iron, and a frame portion made of an aluminum alloy and formed integrally with the crank cap portion. The crank cap portion includes a first peripheral portion extending concentrically with an axis of a crankshaft and including a support surface. The support surface supports the crankshaft and is formed into an arc shape concentric with the axis. The frame portion includes a second peripheral portion extending in an arc shape along the first peripheral portion on a side opposite to the support surface.

### CROSS-REFERENCE TO RELATED APPLICATION

This application is based upon and claims the benefit of priority of the prior Japanese Patent Application No. 2024-182002, filed on Oct. 17, 2024, the entire contents of which are incorporated herein by reference.

### TECHNICAL FIELD

The present disclosure relates to a ladder frame for an engine.

### BACKGROUND

There is a ladder frame of an engine including a crank cap portion made of cast iron and a frame portion made of an aluminum alloy and integrally formed with the crank cap portion (for example, see Japanese Unexamined Patent Application Publication No. 2019-105258).

The crank cap portion rotatably supports a crankshaft. Therefore, a large load is applied to the crank cap portion and the frame portion around the crank cap portion. For example, if a boundary line between the crank cap portion and the frame portion is bent at an acute angle, stress might concentrate in a region of the acute angle. This might cause a crack in the frame portion.

### SUMMARY

It is therefore an object of the present disclosure to provide a ladder frame for an engine in which cracks in a frame portion is suppressed.

The above object is achieved by a ladder frame, for an engine, including: a crank cap portion made of cast iron; and a frame portion made of an aluminum alloy and formed integrally with the crank cap portion, wherein the crank cap portion includes a first peripheral portion extending concentrically with an axis of a crankshaft and including a support surface, the support surface supporting the crankshaft and being formed into an arc shape concentric with the axis, the frame portion includes a second peripheral portion extending in an arc shape along the first peripheral portion on a side opposite to the support surface, and a boundary line between the first peripheral portion and the second peripheral portion includes: an arc region extending in an arc shape along the support surface; a first curved region curved from one end of the arc region in an arc direction toward another end of the arc region in the arc direction on the side opposite to the support surface; and a second curved region curved from the first curved region toward the one end on the side opposite to the support surface.

The first peripheral portion may include: a first front surface continuous with the support surface and intersecting with a direction of the axis; and a first arc surface continuous with the first front surface, extending concentrically with the axis from the first front surface in the direction of the axis, the second peripheral portion may include: a second front surface continuous and flush with the first front surface; and a second arc surface continuous with the second front surface, extending concentrically with the axis from the second front surface in the direction of the axis, and continuous with the first arc surface, the arc region and the first curved region may be a boundary between the first front surface and the second front surface, and the second curved region may be a boundary between the first front surface and the second front surface and a boundary between the first arc surface and the second arc surface.

The crank cap portion may include: a recessed portion located below the first peripheral portion and recessed with respect to the first front surface in the direction of the axis; and a column portion curving from one end of the first peripheral portion in the arc direction and extending downward, the column portion includes a raised portion curving and raising toward another end of the first peripheral portion in the arc direction, the second front surface covers the recessed portion, the first curved region is defined by the first peripheral portion, the column portion, and the raised portion, and the second curved region is defined by the raised portion.

### BRIEF DESCRIPTION OF THE DRAWINGS

FIG. 1A is a schematic view of an engine, and FIG. 1B is a schematic view of a ladder frame;

FIG. 2 is an enlarged view of a crank cap portion;

FIG. 3 is a partially enlarged view of FIG. 2;

FIG. 4 is a partially enlarged view of a comparative example; and

FIG. 5 is a schematic view of a crank cap portion before being cast.

### DETAILED DESCRIPTION

### [Schematic of Engine]

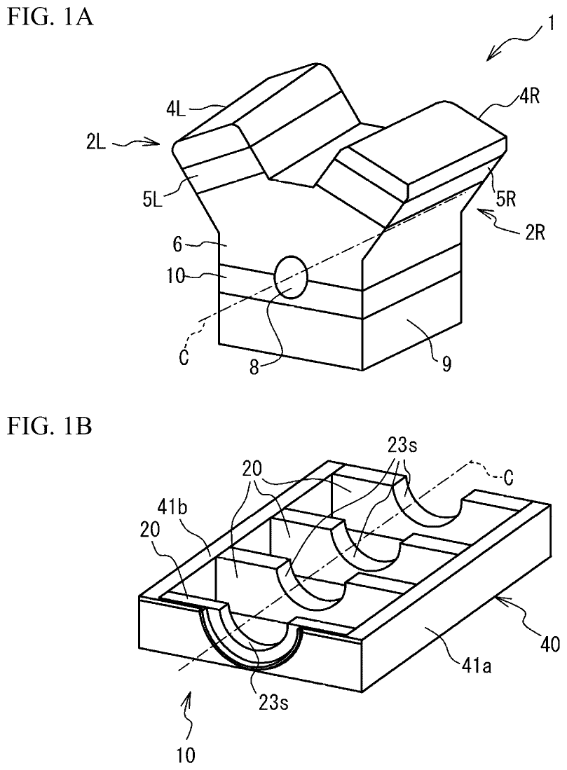

FIG. 1A is a schematic view of an engine 1. The engine 1 is a V-type six cylinder engine having a pair of banks 2L and 2R protruding in a V-shape from an upper portion of a cylinder block 6. The engine 1 is mounted on a vehicle, for example, but is not limited. The engine 1 may be an in-line cylinder engine. The bank 2L includes a cylinder head 5L and a head cover 4L. The cylinder head 5L is installed at an upper end portion of the cylinder block 6. The head cover 4L is attached to an upper end portion of the cylinder head 5L. Similarly, the bank 2R includes a cylinder head 5R and a head cover 4R.

In the cylinder block 6, three cylinders are provided in each of the banks 2L and 2R. A piston is provided in each cylinder. Each piston transmits power to a crankshaft 8. In FIGS. 1A and 1B, an axis C of the crankshaft 8 is indicated by a dotted line. A ladder frame 10 is attached to the lower side of the cylinder block 6. The crankshaft 8 is rotatably supported by the cylinder block 6 and the ladder frame 10. An oil pan 9 storing lubricating oil is attached to the lower side of the ladder frame 10.

### [Schematic of Ladder Frame]

FIG. 1B is a schematic view of the ladder frame 10. The ladder frame 10 includes four crank cap portions 20 and a frame portion 40. The crank cap portion 20 is made of cast iron. The frame portion 40 is made of an aluminum alloy. The four crank cap portions 20 and the frame portion 40 are integrally formed. These four crank cap portions 20 are cast in a mold with molten aluminum alloy. Thus, a molded product in which the four crank cap portions 20 are joined to the frame portion 40 is formed. Thereafter, the molded product is subjected to predetermined machining, whereby the molded product is manufactured as the ladder frame 10.

The frame portion 40 has side wall portions 41a and 41b which are arranged substantially in parallel to each other. The four crank cap portions 20 are joined to the side wall portions 41a and 41b therebetween and are arranged in the direction of the axis C. The crank cap portion 20 located on the most front side in FIG. 1B among the four crank cap portions 20 is different from the other crank cap portions 20 in the shape of the joint portion of the frame portion 40. The crank cap portion 20 has a semicircular support surface 23s formed on the upper side thereof and centered on the axis C. The support surface 23s rotatably supports the crankshaft 8 from below.

### [Configurations of Crank Cap Portion and Frame Portion]

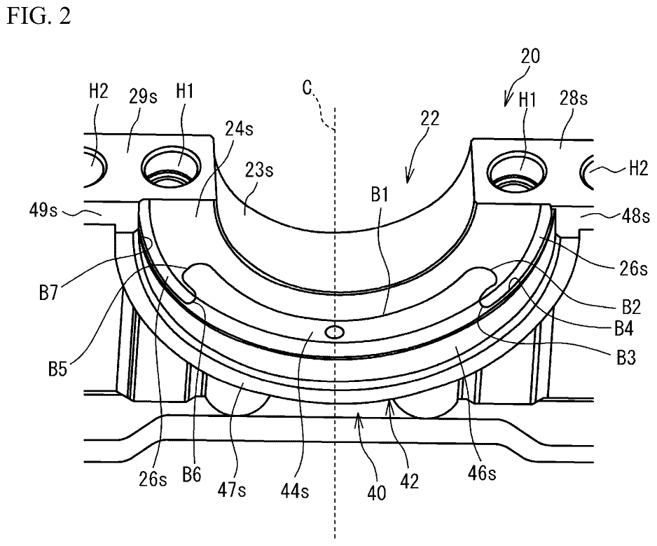

FIG. 2 is an enlarged view of the crank cap portion 20. FIG. 2 is an enlarged view of the crank cap portion 20 located on the most front side in FIG. 1B. The crank cap portion 20 has a first peripheral portion 22. The frame portion 40 has a second peripheral portion 42. The second peripheral portion 42 is continuous with the side wall portions 41a and 41b therebetween. The second peripheral portion 42 is formed integrally with the front surface side of the first peripheral portion 22 of the crank cap portion 20.

The first peripheral portion 22 includes a support surface 23s, a first front surface 24s, and a first arc surface 26s. The support surface 23s has a substantially arc shape concentric with the axis C. The first front surface 24s is continuous with the support surface 23s. The support surface 23s is substantially orthogonal to the axis C. The support surface 23s extends in a substantially arc shape concentric with the axis C. The first arc surface 26s protrudes from the first front surface 24s along the direction of the axis C. The first arc surface 26s extends in a substantially arc shape concentric with the axis C. The first arc surface 26s includes both a portion projecting from one end of the first front surface 24s in the arc direction along the direction of the axis C and a portion projecting from the other end of the first front surface 24s in the arc direction along the direction of the axis C.

The crank cap portion 20 has upper surfaces 28s and 29s formed at positions sandwiching the support surface 23s. The upper surfaces 28s and 29s are in contact with the lower end surface of the cylinder block 6. Bolt holes H1 and H2 are formed in the upper surfaces 28s and 29s, respectively. Bolts for joining the cylinder block 6 and the ladder frame 10 are inserted into the bolt holes H1 and H2, respectively.

The second peripheral portion 42 includes a second front surface 44s, a second arc surface 46s, an end surface 47s, an upper surface 48s, and an upper surface 49s. The second peripheral portion 42 is formed outside the first peripheral portion 22. The second front surface 44s is formed flush with the first front surface 24s. That is, the second front surface 44s is also substantially orthogonal to the axis C and extends in a substantially arc shape, similarly to the first front surface 24s. The second arc surface 46s protrudes from the second front surface 44s along the direction of the axis C. The second arc surface 46s extends in a substantially arc shape concentric with the axis C. The second arc surface 46s and the first arc surface 26s are continuous in the arc direction. The second arc surface 46s and the first arc surface 26s have the same arc radius. The second arc surface 46s includes a portion located between the two first arc surfaces 26s and a portion extending continuously from the portion in the arc direction.

The end surface 47s is continuous with the second arc surface 46s. The end surface 47s is substantially orthogonal to the axis C. The end surface 47s extends in a substantially arc shape concentric with the axis C. The upper surface 48s extends substantially linearly to the sidewall portion 41a continuously from respective one ends, in the arc direction, of the second arc surface 46s and the end surface 46s. The upper surface 48s is flush with the upper surface 28s. The upper surface 49s extends substantially linearly to the sidewall portion 41b continuously from the other ends, in the arc direction, of the second arc surface 46s and the end surface 47s. The upper surface 49s is flush with the upper surface 29s.

As illustrated in FIG. 2, a boundary line between the first peripheral portion 22 and the second peripheral portion 42 is illustrated. The boundary includes an arc region B1, a first curved region B2, a second curved region B3, an arc region B4, a first curved region B5, a second curved region B6, and an arc region B7. The arc region B1 extends concentrically with the axis C in a substantially arc shape along the support surface 23s. The first curved region B2 is curved from one end of the arc region B1 toward the other end thereof in the arc direction on the opposite side to the support surface 23s. The expression “curving on the opposite side to the support surface 23s” means curving away from the support surface 23s. The second curved region B3 is curved from the first curved region B2 to the opposite side of the support surface 23s and to one end side of the arc region B1 in the arc direction. The arc region B4 extends from the second curved region B3 toward the upper surface 48s in the arc shape.

Similarly, the first curved region B5 is curved from the other end of the arc region B1 toward one end thereof in the arc direction in the arc direction on the opposite side to the support surface 23s. The second curved region B6 is curved from the first curved region B5 to the opposite side of the support surface 23s and to the other end side of the arc region B1 in the arc direction. The arc region B7 extends from the second curved region B6 toward the upper surface 49s in the arc shape. The term “curved” means curved in a curved or arched shape, that is, curved in a curved manner.

The arc region B1 and the first curved regions B2 and B5 are boundaries between the first front surface 24s and the second front surface 44s. The second curved regions B3 and B6 are a boundary between the first front surface 24s and the second front surface 44s and a boundary between the first arc surface 26s and the second arc surface 46s. The arc regions B4 and B7 are boundaries between the first arc surface 26s and the second arc surface 46s.

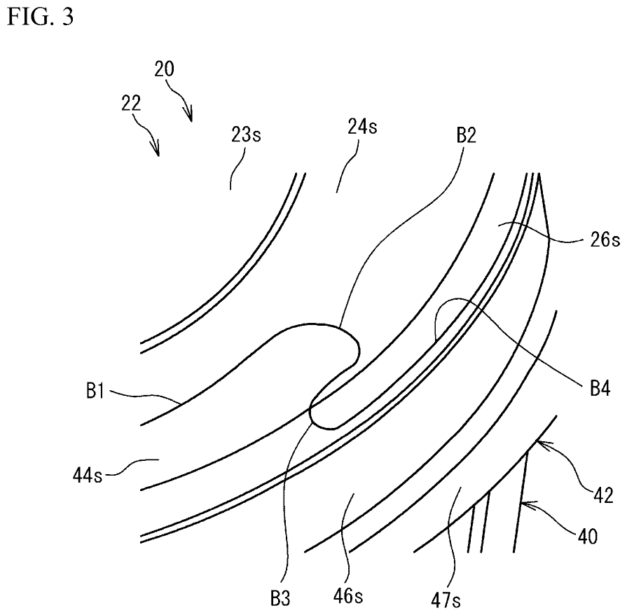

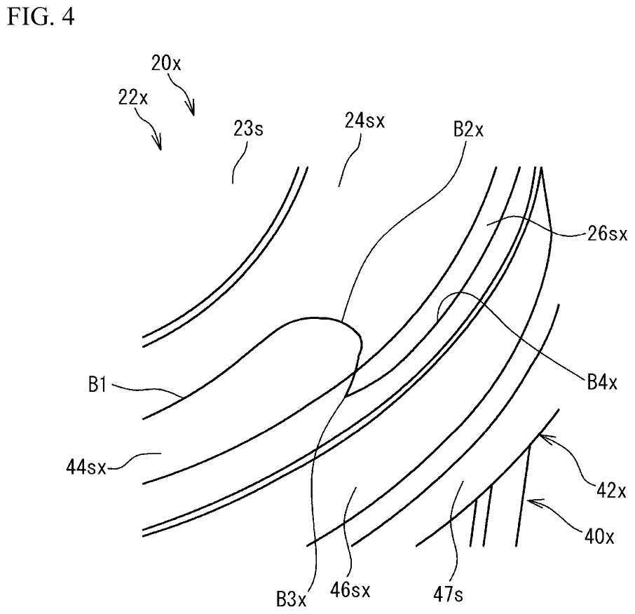

FIG. 3 is a partially enlarged view of FIG. 2. The first curved region B2 and the second curved region B3 are curved. The same applies to the first curved region B5 and the second curved region B6. FIG. 4 is a partially enlarged view of a comparative example. FIG. 4 corresponds to FIG. 3. A first curved region B2x is a boundary between a first front surface 24sx of a first peripheral portion 22x of a crank cap portion 20x and a second front surface 44sx of a second peripheral portion 42x of a frame portion 40x. An acute-angle region B3x is a boundary between a first arc surface 26sx and the second arc surface 46sx.

The first curved region B2x of the comparative example is not curved greatly, unlike the first curved region B2 of the present embodiment. The acute angle region B3x is continuous from the first curved region B2x, is curved at an acute angle, and is continuous to an arcuate region B4x. Thus, the acute angle region B3x is formed at an acute angle. Stresses are likely to concentrate on the acute angle region B3x during operation of the engine. This might cause a crack around the acute angle region B3x. In the present embodiment, the second curved region B3 is curved as illustrated in FIG. 3. Therefore, the concentration of stresses in the second curved region B3 is suppressed, and the occurrence of cracks in the frame portion 40 is suppressed. The term “curved at an acute angle” means that the curved is at an acute angle, that is, the curved is sharp.

### [Schematic of Crank Cap Portion Before Casting]

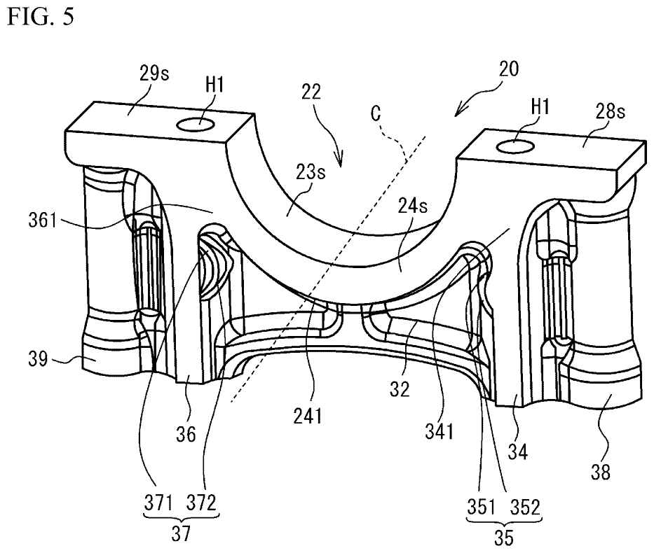

FIG. 5 is a schematic view of the crank cap portion 20 before being cast. The crank cap portion 20 includes the first peripheral portion 22, a recessed portion 32, column portions 34 and 36, raised portions 35 and 37, and outer column portions 38 and 39. The recessed portion 32 is positioned below the first peripheral portion 22. The recessed portion 32 is recessed in the direction of the axis C with respect to the first peripheral portion 22. The column portion 34 is curved and extends downward from one end, in the arc direction, of the first peripheral portion 22. That is, an edge, close to the recessed portion 32, continuous from one end of the first peripheral portion 22 to a root portion 341 of the column portion 34 is curved in an arc shape. The column portion 36 is curved and extends downward from the other end, in the arc direction, of the first peripheral portion 22. An edge, close to the recessed portion 32, continuous from the other end of the first peripheral portion 22 to a root portion 361 of the column portion 36 is curved in an arc shape. The column portions 34 and 36 extend substantially parallel to each other. The column portions 34 and 36 sandwich the recessed portion 32.

The outer column portion 38 is positioned outside the column portion 34. The outer column portion 39 is positioned outside the column portion 36. The outer column portions 38 and 39 extend substantially parallel to the column portions 34 and 36. The bolt hole H1 is formed inside each of the column portions 34 and 36. The bolt hole H2 is formed in each of the outer column portions 38 and 39 by subsequent machining. The strength is secured by the column portions 34 and 36 and the outer column portions 38 and 39.

The raised portion 35 is curved and raised from the column portion 34 toward the other end side, in the arc direction, of the first peripheral portion 22, that is, toward the column portion 36. The raised portion 37 is curved and raised from the column portion 36 toward one end, in the arc direction, of the first peripheral portion 22, that is, toward the column portion 34. In other words, the raised portions 35 and 37 are each raised in a hemispherical shape. The raised portion 35 includes an upper portion 351 and a lower portion 352 of the raised surface. The upper portion 351 is a portion of the raised portion 35 on the first peripheral portion 22 side. The lower portion 352 is a portion of the raised portion 35 on the opposite side to the first peripheral portion 22. Similarly, the raised portion 37 includes an upper portion 371 and a lower portion 372 of the raised surface.

In the molded product after the crank cap portion 20 is cast in the mold with molten aluminum alloy, the second front surface 44s of the second peripheral portion 42 covers the lower side of the first front surface 24s of the recessed portion 32. The ladder frame 10 illustrated in FIG. 2 is formed by machining the molded product to reduce the thickness of the periphery of the first peripheral portion 22 in the direction of the axis C.

The above-described arc region B1 is defined by a substantially arc-shaped lower edge 241 of the first front surface 24s of the first peripheral portion 22. The first curved region B2 is defined by one end of the lower end edge 241 of the first front surface 24s, the root portion 341 of the column portion 34, and the upper portion 351 of the raised portion 35. Similarly, the first curved region B5 is defined by the other end of the lower edge 241 of the first front surface 24s, the root portion 361 of the column portion 36, and the upper portion 371 of the raised portion 37. The second curved region B3 is defined by the lower portion 352 of the raised portion 35. The second curved region B6 is defined by the lower portion 372 of the raised portion 37.

In this way, the first curved region B2, the second curved region B3, the first curved region B5, and the second curved region B6 are curved by the raised portions 35 and 37 of the crank cap portion 20. This suppresses stress concentration and suppresses the occurrence of cracks in the frame portion 40. Further, the crank cap portion 20 having the raised portions 35 and 37 suppresses the occurrence of cracks in the frame portion 40 while suppressing an increase in the mass of the crank cap portion 20.

Although some embodiments of the present disclosure have been described in detail, the present disclosure is not limited to the specific embodiments but may be varied or changed within the scope of the present disclosure as claimed.

What is claimed is:

1. A ladder frame, for an engine, comprising:
a crank cap portion made of cast iron; and
a frame portion made of an aluminum alloy and formed integrally with the crank cap portion,
wherein
the crank cap portion includes a first peripheral portion extending concentrically with an axis of a crankshaft and including a support surface, the support surface supporting the crankshaft and being formed into an arc shape concentric with the axis,
the frame portion includes a second peripheral portion extending in an arc shape along the first peripheral portion on a side opposite to the support surface, and
a boundary line between the first peripheral portion and the second peripheral portion includes:
an arc region extending in an arc shape along the support surface;
a first curved region curved from one end of the arc region in an arc direction toward another end of the arc region in the arc direction on the side opposite to the support surface; and
a second curved region curved from the first curved region toward the one end on the side opposite to the support surface.

2. The ladder frame, for an engine, according to claim 1, wherein
the first peripheral portion includes:
a first front surface continuous with the support surface and intersecting with a direction of the axis; and
a first arc surface continuous with the first front surface, extending concentrically with the axis from the first front surface in the direction of the axis,
the second peripheral portion includes:
a second front surface continuous and flush with the first front surface; and
a second arc surface continuous with the second front surface, extending concentrically with the axis from the second front surface in the direction of the axis, and continuous with the first arc surface,
the arc region and the first curved region are a boundary between the first front surface and the second front surface, and
the second curved region is a boundary between the first front surface and the second front surface and a boundary between the first arc surface and the second arc surface.

3. The ladder frame, for an engine, according to claim 2, wherein
the crank cap portion includes:
a recessed portion located below the first peripheral portion and recessed with respect to the first front surface in the direction of the axis; and
a column portion curving from one end of the first peripheral portion in the arc direction and extending downward,
the column portion includes a raised portion curving and raising toward another end of the first peripheral portion in the arc direction,
the second front surface covers the recessed portion,
the first curved region is defined by the first peripheral portion, the column portion, and the raised portion, and
the second curved region is defined by the raised portion.
